(19) United States
(12) Patent Application Publication
(10) Pub. No.: US 2015/0232705 A1
(43) Pub. Date: Aug. 20, 2015

(54) POLISHING COMPOSITION

(71) Applicant: FUJIMI INCORPORATED, Kiyosu-si, Aichi (JP)

(72) Inventors: Yoshihiro Kachi, Kiyosu-shi (JP); Akihito Yasui, Kiyosu-shi (JP); Yoshihiro Izawa, Kiyosu-shi (JP); Takahiro Umeda, Kiyosu-shi (JP)

(73) Assignee: FUJIMI INCORPORATED, Kiyosu-shi, Aichi (JP)

(21) Appl. No.: 14/428,297

(22) PCT Filed: Aug. 23, 2013
(86) PCT No.: PCT/JP2013/072601

§ 371 Date: Mar. 13, 2015

(30) Foreign Application Priority Data
Sep. 14, 2012 (JP) 2012-203104

(51) Int. Cl. C09G 1/18; C23F 1/02

(52) U.S. Cl. CPC C09G 1/18; C23F 1/02

(57) ABSTRACT

To provide a polishing composition, in which a high polishing rate for a barrier layer and an insulation film can sufficiently be maintained, a polishing rate of a low dielectric material can sufficiently be suppressed, and aggregation of abrasive grains can be prevented. The invention is a polishing composition to be used for an application of polishing a polishing object having a barrier layer, a metal wiring layer, and an insulation film, comprising an oxidizing agent, and a nonionic compound having a weight average molecular weight of 1,000 or less.

### TECHNICAL FIELD

The present invention relates to a polishing composition.

### BACKGROUND ART

In recent years, new fine processing techniques have been developed along with high integration and high performance of LSI. A chemical mechanical polishing (hereinafter, also simply referred to as “CMP”) method is one of the techniques, and is a technique frequently used for planarization of an interlayer insulation film, metal plug formation, and buried wiring (damascene wiring) formation in an LSI production process, in particular, in a multilayer wiring forming process.

The common method of CMP is as follows: a polishing pad is attached on a circular polishing surface plate (platen); the surface of the polishing pad is immersed with a polishing agent; a surface of a substrate, to which a metal film is formed, is pressed; the polishing surface plate is rotated while a predetermined pressure (hereinafter, simply referred to as “polishing pressure”) is applied to the substrate from the back side thereof; and the metal film in projecting part is removed by the mechanical friction between the polishing agent and the projecting part of the metal film.

On the other hand, in the lower layer of copper, a copper alloy, or the like in the wiring, tantalum, a tantalum alloy, a tantalum compound, or the like is formed as a barrier layer in order to prevent the copper from diffusing into the interlayer insulation film. Therefore, in the parts other than the wiring part to which copper or a copper alloy is buried, the exposed barrier layer is necessary to be removed by CMP.

In order to form each wiring layer, the following is generally performed: firstly, CMP of metal film, in which the excess wiring material applied by a plating method or the like is removed, (hereinafter, also referred to as “metal film CMP”) is performed in one step or over multiple steps; and secondly CMP, in which the barrier layer exposed on the surface by the metal film CMP is removed (hereinafter, also referred to as “barrier layer CMP”), is generally performed. However, to excessively polish the wiring part by metal film CMP, so-called dishing, and additionally to cause erosion become a problem.

In order to reduce the dishing, it is required that in the barrier layer CMP which is performed next to the metal film CMP, a wiring layer having little difference in level of dishing, erosion, and the like is finally formed by the adjustment of the polishing rate of the metal wiring part and the polishing rate of the barrier metal part. That is, in barrier layer CMP, in a case where the polishing rate of the barrier layer and the interlayer insulation film is relatively smaller as compared with that of the metal wiring part, dishing in which the wiring part is quickly polished, and erosion resulted from the dishing occurs; therefore, the polishing rate of the barrier layer and insulation film is desirably appropriately large. This is because there is an advantage to enhance throughput of barrier layer CMP and also it is desirable that dishing is practically generated by the metal film CMP in many cases and it is required to relatively increase the polishing rate of the barrier layer and the insulation film from the reason described above.

Furthermore, recently, an insulation film (Low-k film) having a lower dielectric constant and low strength has come to be used. This is because the distance between the wirings is close in a state-of-the-art device, and, when an insulation film having high dielectric constant is used, an electrical failure may occur between the wirings. Such a Low-k film has extremely low strength and there was a problem of excessive reduction in the processing of CMP. Therefore, a technique for highly maintaining the polishing rate to the film to be polished during the polishing of the barrier layer and sufficiently suppressing the polishing rate to the Low-k film is required.

As such a technique, for example, in JP 2008-243997 A, there is a disclosure of a polishing liquid for polishing a barrier layer of a semiconductor integrated circuit, in which an antistatic agent and a specific cationic compound are contained. In addition, in JP-2010-028078 A, JP 2010-028079 A (WO 2009/104465), JP 2010-028080 A, and JP 2010-028081 A (U.S. Patent Application Serial No. 2011/081780), there is a disclosure of a polishing liquid comprising silica particles, an organic acid, and a water-soluble polymer having a weight average molecular weight of 50,000 or more to 1,000,000 or less.

### SUMMARY OF INVENTION

However, in the polishing liquids described in the above-described Patent Literatures, the maintenance of the high polishing rate to a barrier layer and an insulation film, and the suppression of the polishing rate of a low dielectric material are still insufficient, and further improvement has been required. In addition, in the polishing liquids described in JP-2010-028078 A, JP-2010-028079 A (WO 2009/104465), JP-2010-028080 A, and JP-2010-028081 A (U.S. Patent Application Serial No. 2011/081780), there is also a problem that when abrasive grains are used, the abrasive grains are aggregated and the polishing becomes difficult.

Therefore, the purpose of the invention is to provide a polishing composition, in which a high polishing rate to a barrier layer and an insulation film can sufficiently be maintained, a polishing rate of a low dielectric material can sufficiently be suppressed, and aggregation of abrasive grains can be prevented.

The inventors accumulated intensive studies to solve the problems described above. As a result, the inventors found that the above problems can be solved by using a polishing composition comprising an oxidizing agent and a nonionic compound having a weight average molecular weight of 1,000 or less. Thus, the invention has been completed based on the above knowledge.

That is, the invention is a polishing composition to be used for an application of polishing a polishing object having a barrier layer, a metal wiring layer, and an insulation film, in which an oxidizing agent and a nonionic compound having a weight average molecular weight of 1,000 or less are comprised.

### DESCRIPTION OF EMBODIMENTS

The invention is a polishing composition to be used for an application of polishing a polishing object having a barrier layer, a metal wiring layer, and an insulation film, in which an oxidizing agent and a nonionic compound having a weight average molecular weight of 1,000 or less are comprised. With such constitution, a high polishing rate to a barrier layer and an insulation film can sufficiently be maintained, a polishing rate of a low dielectric material can sufficiently be suppressed, and aggregation of abrasive grains can be prevented.

Detailed reasons that the effects as described above can be obtained by using a polishing composition of the invention are unknown; however, it is considered that the nonionic compound used in the invention has a low molecular weight, and a protective film having a thickness of around that of the nonionic compound having high molecular weight is not formed, and the polishing rate of the low dielectric material can be suppressed without lowering the polishing rate of the barrier layer and the insulation film. In addition, it is considered that the nonionic compound having a low molecular weight according to the invention has a weak effect of aggregating multiple abrasive grains in spite of having an effect onto the surface of the abrasive grains, and thus it can prevent the aggregation of the abrasive grains. The above-described mechanism is due to estimation, and the invention is not limited at all by the mechanism.

### [Polishing Object]

A polishing object according to the invention has a barrier layer, a metal wiring layer, and an insulation film, and has a low dielectric material as needed.

A material comprised in the barrier layer is not particularly limited, and examples of which comprise, for example, tantalum, titanium, tungsten and cobalt; and a noble metal such as gold, silver, platinum, palladium, rhodium, ruthenium, iridium, and osmium. These metals may be comprised in the barrier layer in a form of an alloy or a metal compound. Tantalum or a noble metal is preferable. These metals may be used alone or in combination of two or more members.

In addition, a metal comprised in the metal wiring layer is not particularly limited, and examples of which comprise, for example, copper, aluminum, hafnium, cobalt, nickel, titanium and tungsten. These metals may be comprised in the metal wiring layer in a form of an alloy or a metal compound. Copper, or a copper alloy is preferable. These metals may be used alone or in combination of two or more members.

An example of the material comprised in the insulation film comprises TEOS (tetraethoxysilane).

Specific examples of the low dielectric material comprise the member abbreviated generally as Low-k, having a relative dielectric constant of about 3.5 to 2.0, and comprise, for example, silicon oxycarbide (SiOC) (for example, Black Diamond (registered trademark) manufactured by Applied Materials, Inc.), fluorine-containing silicon oxide (SiOF), and an organic polymer.

Next, a constitution of the polishing composition of the invention will be described in detail below.

### [Oxidizing Agent]

Specific examples of the oxidizing agent according to the invention comprise hydrogen peroxide, peracetic acid, a percarbonate, urea peroxide and perchloric acid; and a persulfate such as sodium persulfate, potassium persulfate, and ammonium persulfate. These oxidizing agents may be used alone or in the mixture of two or more members.

Among them, a persulfate and hydrogen peroxide are preferable, and hydrogen peroxide is particularly preferable.

The lower limit of the content (concentration) of the oxidizing agent in the polishing composition is preferably 0.01% by weight or more, more preferably 0.05% by weight or more, and further preferably 0.1% by weight or more. There is an advantage that as the content of the oxidizing agent increases, the polishing rate of the polishing composition is improved.

In addition, the upper limit of the content (concentration) of the oxidizing agent in the polishing composition is preferably 10% by weight or less, more preferably 5% by weight or less, and further preferably 3% by weight or less. There is an advantage that as the content of the oxidizing agent decreases, the material cost of the polishing composition can be suppressed, and also disposal of the polishing composition after polishing, that is, a load on waste liquid treatment can be reduced. Furthermore, there is also an advantage that excessive oxidation on the surface of the polishing object by the oxidizing agent hardly occurs.

### [Nonionic Compound]

The nonionic compound according to the invention has a weight average molecular weight of 1,000 or less. In a case where the weight average molecular weight exceeds 1,000, aggregation of abrasive grains occurs, and the suppression of the polishing rate of the low dielectric material becomes difficult. The weight average molecular weight is preferably 950 or less, and more preferably 900 or less.

The lower limit of the weight average molecular weight is not particularly limited. However, from the viewpoint of the suppressive effect of the polishing rate to the low dielectric material, the lower limit is preferably 200 or more, and more preferably 300 or more.

Furthermore, the weight average molecular weight can be measured by gel permeation chromatography (GPC) using polystyrene as a standard substance.

Specific examples of the nonionic compound include, for example, an ether-type surfactant such as polyoxypropylene polyoxyethylene glycol, polyoxypropylene polyoxyethylene alkyl ether, polyoxyethylene alkyl ether, polyoxyethylene alkyl allyl ether, a polyoxyethylene polyoxypropylene ether derivative, polyoxypropylene glyceryl ether, polyethylene glycol, polypropylene glycol, methoxypolyethylene glycol, and an oxyethylene adduct of acetylene-based diol; an ester-type surfactant such as sorbitan fatty acid ester, and glycerol borate fatty acid ester; an aminoether-type surfactant such as polyoxyethylene alkylamine; an ether-ester type surfactant such as polyoxyethylene sorbitan fatty acid ester, polyoxyethylene glycerol borate fatty acid ester, and polyoxyethylene alkyl ester; an alkanolamide-type surfactant such as fatty acid alkanolamide, and polyoxyethylene fatty acid alkanolamide; an oxyethylene adduct of acetylene-based diol, polyvinyl pyrrolidone, polyacrylamide, polydimethylacrylamide, polyvinyl alcohol, a polysaccharide such as carboxymethyl cellulose, agar, curdlan, and pullulan, a polycarboxylic acid such as polyaspartic acid, polyglutamic acid, polylysine, polymaleic acid, polyamic acid, a polyamic acid ammonium salt, a polyamic acid sodium salt, and polyglyoxylic acid, and a salt thereof. These nonionic compounds may be used alone or in the mixture of two or more members. Furthermore, as the nonionic compound, a commercial product or a synthetic product may be used.

Among these nonionic compounds, from the viewpoint of the suppressive effect of the polishing rate on the low dielectric material, a compound having an alkyl ether chain is preferable, and the alkyl ether chain preferably has a structure represented by the following chemical formula (1) or (2).

[Chem. 1]

—(CH₂CH₂O)ₙ— (1)

—(CH₂CH₂CH₂O)ₘ— (2)

In the chemical formula (1), n is an integer of 1 to 23, and in the chemical formula (2), m is an integer of 1 to 15.

More specifically, polyoxypropylene polyoxyethylene glycol, polyoxyethylene alkyl ether, polyethylene glycol, and polypropylene glycol are preferable.

The lower limit of the content of the nonionic compound in the polishing composition is preferably 0.01 g/L or more, more preferably 0.05 g/L or more, and further preferably 0.1 g/L or more. There is an advantage that as the content of the nonionic compound increases, the suppressive effect of the polishing rate on the low dielectric material is increased.

Furthermore, the upper limit of the content of the nonionic compound in the polishing composition is preferably 15 g/L or less, more preferably 10 g/L or less, and further preferably 5 g/L or less. There is an advantage that as the content of the nonionic compound decreases, the aggregation of the abrasive grains can easily be suppressed.

### [Water]

The polishing composition of the invention preferably comprises water as a dispersion medium or a solvent to disperse or to dissolve each component. From the viewpoint of suppressing the inhibition of the action of other components, water not containing impurities as much as possible is preferable, specifically pure water or ultrapure water, in which impurity ions are removed by an ion exchange resin and then foreign matters are removed through a filter, or distilled water is preferable.

### [Other Components]

The polishing composition of the invention may further comprise other components such as abrasive grains, a complexing agent, a metal corrosion inhibitor, an antiseptic, a fungicide, an oxidizing agent, a reducing agent, a water-soluble polymer, a surfactant, and an organic solvent in order to dissolve a hardly-soluble organic substance, as needed. Hereinafter, the abrasive grains, complexing agent, and metal corrosion inhibitor that are preferable other components will be explained.

### [Abrasive Grains]

The abrasive grains comprised in the polishing composition have an action of mechanically polishing the polishing object, and improve the polishing rate of the polishing object by the polishing composition.

The abrasive grains to be used may be anyone of inorganic particles, organic particles, and organic-inorganic composite particles. Specific examples of the inorganic particles include, for example, particles consisting of a metal oxide such as silica, alumina, ceria, and titania; silicon nitride particles; silicon carbide particles; and boron nitride particles. Specific examples of the organic particles include, for example, polymethyl methacrylate (PMMA) particles. The abrasive grains may be used alone or in the mixture of two or more members. Furthermore, as the abrasive grains, a commercial product or a synthetic product may be used.

Among these abrasive grains, silica is preferable, and colloidal silica is particularly preferable.

The abrasive grains may be surface-modified. In the ordinary colloidal silica, the value of zeta potential is close to zero under an acidic condition; therefore, the silica particles do not electrically repel each other and tend to be aggregated under an acidic condition. On the other hand, the abrasive grains that are surface-modified such that the zeta potential even under an acidic condition has a relatively large negative value, strongly repel each other even under an acidic condition and are satisfactorily dispersed. As a result, the storage stability of the polishing composition can be improved. Such surface-modified abrasive grains can be obtained, for example, by mixing a metal such as aluminum, titanium, or zirconium, or an oxide thereof with abrasive grains to dope it on the surfaces of the abrasive grains.

Among them, colloidal silica in which an organic acid is immobilized is particularly preferable. The immobilization of organic acid to the surface of the colloidal silica comprised in the polishing composition is performed, for example, by chemically bonding a functional group of the organic acid onto the surface of colloidal silica. The immobilization of organic acid on colloidal silica cannot be achieved only by simply allowing the colloidal silica to coexist with the organic acid. When sulfonic acid, one member of organic acids, is immobilized on colloidal silica, the immobilization can be performed, for example, by using a method described in “Sulfonic acid-functionalized silica through quantitative oxidation of thiol groups”, Chem. Commun. 246-247 (2003). Specifically, a silane coupling agent having a thiol group such as 3-mercaptopropyl trimethoxysilane is coupled with colloidal silica, then the thiol group is oxidized with hydrogen peroxide, and as a result, colloidal silica where sulfonic acid has immobilized on the surface can be obtained. Alternatively, when carboxylic acid is immobilized on colloidal silica, the immobilization can be performed, for example, by using a method described in “Novel Silane Coupling Agents Containing a Photolabile 2-Nitrobenzyl Ester for Introduction of a Carboxy Group on the Surface of Silica Gel”, Chemistry Letters, 3, 228-229 (2000). Specifically, a silane coupling agent comprising a photoreactive 2-nitrobenzyl ester is coupled with colloidal silica, then the resultant is photoirradiated, and as a result, colloidal silica where carboxylic acid has immobilized on the surface can be obtained.

The lower limit of the average primary particle diameter of the abrasive grains is preferably 5 nm or more, more preferably 7 nm or more, and further preferably 10 nm or more. Furthermore, the upper limit of the average primary particle diameter of the abrasive grains is preferably 500 nm or less, more preferably 100 nm or less, and further preferably 70 nm or less. As long as the average primary particle diameter is in such a range, the polishing rate of the polishing object by the polishing composition is improved, and also it can be suppressed more from causing dishing on the surface of the polishing object after the polishing by using the polishing composition. In addition, the average primary particle diameter of the abrasive grains is calculated, for example, based on the specific surface area of the abrasive grains measured by a BET method.

The lower limit of the content of the abrasive grains in the polishing composition is preferably 0.005% by weight or more, more preferably 0.5% by weight or more, further preferably 1% by weight or more, and most preferably 3% by weight or more. In addition, the upper limit of the content of the abrasive grains in the polishing composition is preferably 50% by weight or less, more preferably 30% by weight or less, and further preferably 15% by weight or less. As long as the content of the abrasive grains is in such a range, the polishing rate of the polishing object is improved, the cost of the polishing composition can be suppressed, and it can be suppressed more from causing dishing on the surface of the polishing object after the polishing by using the polishing composition.

### [Complexing Agent]

The complexing agent comprised in the polishing composition has an action of chemically etching the surface of the polishing object, and improves the polishing rate of the polishing object by the polishing composition.

Examples of the usable complexing agent include, for example, an inorganic acid or a salt thereof, an organic acid or a salt thereof, a nitrile compound, an amino acid, and a chelating agent. These complexing agents may be used alone or in the mixture of two or more members. Furthermore, as the complexing agent, a commercial product or a synthetic product may be used.

Specific examples of the inorganic acid include, for example, hydrochloric acid, sulfuric acid, nitric acid, carbonic acid, boric acid, tetrafluoroboric acid, hypophosphorous acid, phosphorous acid, phosphoric acid, and pyrophosphoric acid.

Specific examples of the organic acid include a carboxylic acid such as a monovalent carboxylic acid including formic acid, acetic acid, propionic acid, butyric acid, valeric acid, 2-methylbutyric acid, n-hexanoic acid, 3,3-dimethylbutyric acid, 2-ethylbutyric acid, 4-methylpentanoic acid, n-heptanoic acid, 2-methylhexanoic acid, n-octanoic acid, 2-ethylhexanoic acid, lactic acid, glycolic acid, glyceric acid, benzoic acid, and salicylic acid; and a polyvalent carboxylic acid including oxalic acid, malonic acid, succinic acid, glutaric acid, gluconic acid, adipic acid, pimelic acid, maleic acid, phthalic acid, fumaric acid, malic acid, tartaric acid, and citric acid. Furthermore, a sulfonic acid such as methanesulfonic acid, ethanesulfonic acid, and isethionic acid can also be used.

As the complexing agent, a salt of the inorganic acid or the organic acid may be used. In particular, in a case where a salt of a weak acid and a strong base, a salt of a strong acid and a weak base, or a salt of a weak acid and a weak base is used, buffering action of pH can be expected. Examples of the salt include, for example, potassium chloride, sodium sulfate, potassium nitrate, potassium carbonate, potassium tetrafluoroborate, potassium pyrophosphate, potassium oxalate, trisodium citrate, (+)-potassium tartrate, and potassium hexafluorophosphate.

Specific examples of the nitrile compound include, for example, acetonitrile, aminoacetonitrile, propionitrile, butyronitrile, isobutyronitrile, benzonitrile, glutarodinitrile, and methoxyacetonitrile.

Specific examples of the amino acid include glycine, α-alanine, β-alanine, N-methylglycine, N,N-dimethylglycine, 2-aminobutyric acid, norvaline, valine, leucine, norleucine, isoleucine, phenylalanine, proline, sarcosine, ornithine, lysine, taurine, serine, threonine, homoserine, tyrosine, bicine, tricine, 3,5-diiodo-tyrosine, β-(3,4-dihydroxyphenyl)-alanine, thyroxine, 4-hydroxy-proline, cysteine, methionine, ethionine, lanthionine, cystathionine, cystine, cysteic acid, aspartic acid, glutamic acid, S-(carboxymethyl)-cysteine, 4-aminobutyric acid, asparagine, glutamine, azaserine, arginine, canavanine, citrulline, δ-hydroxy-lysine, creatine, histidine, 1-methyl-histidine, 3-methyl-histidine, and tryptophan.

Specific examples of the chelating agent include nitrilotriacetic acid, diethylenetriaminepenta-acetic acid, ethylenediaminetetraacetic acid, N,N,N-trimethylene phosphonic acid, ethylenediamine-N,N,N′,N′-tetramethylene-sulfonic acid, trans-cyclohexanediaminetetraacetic acid, 1,2-diaminopropane tetraacetic acid, glycol ether diaminetetraacetic acid, ethylenediamine orthohydroxyphenylacetic acid, ethylenediamine disuccinic acid (SS form), N-(2-carboxylate ethyl)-L-aspartic acid, β-alanine diacetic acid, 2-phosphonobutane-1,2,4-tricarboxylic acid, 1-hydroxyethylidene-1,1-diphosphonic acid, N,N′-bis(2-hydroxybenzyl)ethylenediamine-N,N′-diacetic acid, and 1,2-dihydroxybenzene-4,6-disulfonic acid.

Among them, at least one member selected from the group consisting of an inorganic acid or a salt thereof, a carboxylic acid or a salt thereof, and a nitrile compound is preferable, and from the viewpoint of the stability of the complex structure with a noble metal compound, an inorganic acid or a salt thereof is more preferable.

The lower limit of the content (concentration) of the complexing agent in the polishing composition is not particularly limited because the complexing agent exerts an effect even in a small amount; however, 0.001 g/L or more is preferable, more preferably 0.01 g/L or more, and further preferably 1 g/L or more. Furthermore, the upper limit of the content (concentration) of the complexing agent in the polishing composition of the invention is preferably 20 g/L or less, more preferably 15 g/L or less, and further preferably 10 g/L or less. As long as the content is in this range, an effect of the invention can be obtained more efficiently.

### [Metal Corrosion Inhibitor]

With the addition of a metal corrosion inhibitor into the polishing composition, occurrence of a depression beside the wiring due to the polishing using the polishing composition can be suppressed more. Furthermore, occurrence of dishing on the surface of the object to be polished after the polishing using the polishing composition can be suppressed more.

The usable metal corrosion inhibitor is not particularly limited; however, a heterocyclic compound or a surfactant is preferable. The number of members in the heterocyclic ring in the heterocyclic compound is not particularly limited. In addition, the heterocyclic compound may be a monocyclic compound, or may be a polycyclic compound having a condensed ring. The metal corrosion inhibitor may be used alone or in the mixture of two or more members. Furthermore, as the metal corrosion inhibitor, a commercial product or a synthetic product may be used.

Specific examples of the heterocyclic compound usable as the metal corrosion inhibitor include, for example, a nitrogen-containing heterocyclic compound such as a pyrrole compound, a pyrazole compound, an imidazole compound, a triazole compound, a tetrazole compound, a pyridine compound, a pyrazine compound, a pyridazine compound, a pyrindine compound, an indolizine compound, an indole compound, an isoindole compound, an indazole compound, a purine compound, a quinolizine compound, a quinoline compound, an isoquinoline compound, a naphthyridine compound, a phthalazine compound, a quinoxaline compound, a quinazoline compound, a cinnoline compound, a pteridine compound, a triazole compound, an isothiazole compound, an oxazole compound, an isoxazole compound, and a furazan compound.

As the further specific examples, examples of the pyrazole compound include, for example, 1H-pyrazole, 4-nitro-3-pyrazolecarboxylic acid, 3,5-pyrazolecarboxylic acid, 3-amino-5-phenylpyrazole, 5-amino-3-phenylpyrazole, 3,4,5-tribromopyrazole, 3-aminopyrazole, 3,5-dimethylpyrazole, 3,5-dimethyl-1-hydroxymethylpyrazole, 3-methylpyrazole, 1-methylpyrazole, 3-amino-5-methylpyrazole, 4-amino-pyrazolo[3,4-d]pyrimidine, allopurinol, 4-chloro-1H-pyrazolo[3,4-D]pyrimidine, 3,4-dihydroxy-6-methylpyrazolo (3,4-B)-pyridine, and 6-methyl-1H-pyrazolo[3,4-b]pyridine-3-amine.

Examples of the imidazole compound include, for example, imidazole, 1-methylimidazole, 2-methylimidazole, 4-methylimidazole, 1,2-dimethylpyrazole, 2-ethyl-4-methylimidazole, 2-isopropylimidazole, benzimidazole, 5,6-dimethylbenzimidazole, 2-aminobenzimidazole, 2-chlorobenzimidazole, 2-methylbenzimidazole, 2-(1-hydroxyethyl)benzimidazole, 2-hydroxybenzimidazole, 2-phenylbenzimidazole, 2,5-dimethylbenzimidazole, 5-methylbenzimidazole, 5-nitrobenzimidazole, and 1H-purine.

Examples of the triazole compound include, for example, 1,2,3-triazole (1H-BTA), 1,2,4-triazole, 1-methyl-1,2,4-triazole, methyl-1H-1,2,4-triazole-3-carboxylate, 1,2,4-triazole-3-carboxylic acid, 1,2,4-triazole-3-methyl carboxylate, 1H-1,2,4-triazole-3-thiol, 3,5-diamino-1H-1,2,4-triazole, 3-amino-1,2,4-triazole-5-thiol, 3-amino-1H-1,2,4-triazole, 3-amino-5-benzyl-4H-1,2,4-triazole, 3-amino-5-methyl-4H-1,2,4-triazole, 3-nitro-1,2,4-triazole, 3-bromo-5-nitro-1,2,4-triazole, 4-(1,2,4-triazole-1-yl)phenol, 4-amino-1,2,4-triazole, 4-amino-3,5-dipropyl-4H-1,2,4-triazole, 4-amino-3,5-dimethyl-4H-1,2,4-triazole, 4-amino-3,5-diheptyl-4H-1,2,4-triazole, 5-methyl-1,2,4-triazole-3,4-diamine, 1H-benzotriazole, 1-hydroxybenzotriazole, 1-aminobenzotriazole, 1-carboxybenzotriazole, 5-chloro-1H-benzotriazole, 5-nitro-1H-benzotriazole, 5-carboxy-1H-benzotriazole, 5-methyl-1H-benzotriazole, 5,6-dimethyl-1H-benzotriazole, 1-(1′,2′-dicarboxyethyl)benzotriazole, 1-[N,N-bis(hydroxyethyl)aminomethyl]benzotriazole, 1-[N,N-bis(hydroxyethyl)aminomethyl]-5-methylbenzotriazole, and 1-[N,N-bis(hydroxyethyl)aminomethyl]-4-methylbenzotriazole.

Examples of the tetrazole compound include, for example, 1H-tetrazole, 5-methyltetrazole, 5-aminotetrazole, and 5-phenyltetrazole.

Examples of the indazole compound include, for example, 1H-indazole, 5-amino-1H-indazole, 5-nitro-1H-indazole, 5-hydroxy-1H-indazole, 6-amino-1H-indazole, 6-nitro-1H-indazole, 6-hydroxy-1H-indazole, and 3-carboxy-5-methyl-1H-indazole.

Examples of the indole compound include, for example, 1H-indole, 1-methyl-1H-indole, 2-methyl-1H-indole, 3-methyl-1H-indole, 4-methyl-1H-indole, 5-methyl-1H-indole, 6-methyl-1H-indole, 7-methyl-1H-indole, 4-amino-1H-indole, 5-amino-1H-indole, 6-amino-1H-indole, 7-amino-1H-indole, 4-hydroxy-1H-indole, 5-hydroxy-1H-indole, 6-hydroxy-1H-indole, 7-hydroxy-1H-indole, 4-methoxy-1H-indole, 5-methoxy-1H-indole, 6-methoxy-1H-indole, 7-methoxy-1H-indole, 4-chloro-1H-indole, 5-chloro-1H-indole, 6-chloro-1H-indole, 7-chloro-1H-indole, 4-carboxy-1H-indole, 5-carboxy-1H-indole, 6-carboxy-1H-indole, 7-carboxy-1H-indole, 4-nitro-1H-indole, 5-nitro-1H-indole, 6-nitro-1H-indole, 7-nitro-1H-indole, 4-nitrile-1H-indole, 5-nitrile-1H-indole, 6-nitrile-1H-indole, 7-nitrile-1H-indole, 2,5-dimethyl-1H-indole, 1,2-dimethyl-1H-indole, 1,3-dimethyl-1H-indole, 2,3-dimethyl-1H-indole, 5-amino-2,3-dimethyl-1H-indole, 7-ethyl-1H-indole, 5-(aminomethyl)indole, 2-methyl-5-amino-1H-indole, 3-hydroxymethyl-1H-indole, 6-isopropyl-1H-indole, and 5-chloro-2-methyl-1H-indole.

Among them, the heterocyclic compound is preferably a triazole compound, and in particular, 1H-benzotriazole, 5-methyl-1H-benzotriazole, 5,6-dimethyl-1H-benzotriazole, 1-[N,N-bis(hydroxyethyl)aminomethyl]-5-methylbenzotriazole, 1-[N,N-bis(hydroxyethyl)aminomethyl]-4-methylbenzotriazole, 1,2,3-triazole, and 1,2,4-triazole are preferable. These heterocyclic compounds have high chemical or physical adsorption force onto the surface of the polishing object; therefore, a stronger protective film can be formed on the surface of the polishing object. This is advantageous for improving the flatness of the surface of the polishing object after the polishing by using the polishing composition of the invention.

In addition, examples of the surfactant used as a metal corrosion inhibitor include an anionic surfactant, a cationic surfactant, and an amphoteric surfactant.

Examples of the anionic surfactant include, for example, polyoxyethylene alkyl ether acetic acid, polyoxyethylene alkyl sulfuric acid ester, alkyl sulfuric acid ester, polyoxyethylene alkyl ether sulfuric acid, alkyl ether sulfuric acid, alkylbenzene sulfonic acid, alkyl phosphoric acid ester, polyoxyethylene alkyl phosphoric acid ester, polyoxyethylene sulfosuccinic acid, alkylsulfosuccinic acid, alkylnaphthalenesulfonic acid, alkyl diphenyl ether disulfonic acid, and a salt thereof.

Examples of the cationic surfactant include, for example, an alkyltrimethylammonium salt, an alkyldimethylammonium salt, an alkylbenzyldimethylammonium salt, and an alkyl amine salt.

Examples of the amphoteric surfactant include, for example, alkylbetaine, and alkylamine oxide.

Among them, the surfactant is preferably polyoxyethylene alkyl ether acetic acid, a polyoxyethylene alkyl ether sulfate, an alkyl ether sulfate, and an alkyl benzene sulfonate. These surfactants have high chemical or physical adsorption force onto the surface of the polishing object; therefore, a stronger protective film can be formed on the surface of the polishing object. This is advantageous for improving the flatness of the surface of the polishing object after the polishing by using the polishing composition of the invention.

The lower limit of the content of the metal corrosion inhibitor in the polishing composition is preferably 0.001 g/L or more, more preferably 0.005 g/L or more, and further preferably 0.01 g/L or more. Furthermore, the upper limit of the content of the metal corrosion inhibitor in the polishing composition is preferably 10 g/L or less, more preferably 5 g/L or less, and further preferably 2 g/L or less. As long as the content of the metal corrosion inhibitor is in such a range, the flatness of the surface of the polishing object after the polishing by using the polishing composition is improved, and also, the polishing rate of the polishing object by the polishing composition is improved.

### [pH of Polishing Composition]

The lower limit of the pH of the polishing composition of the invention is preferably 3 or more. As the pH of the polishing composition increases, the risk where the excessive etching occurs on the surface of the polishing object by the polishing composition can be reduced.

Furthermore, the upper limit of the pH of the polishing composition is preferably 10 or less. As the pH of the polishing composition decreases, occurrence of a depression formed beside the wiring due to the polishing using the polishing composition can be more suppressed.

A pH adjusting agent may be used in order to adjust the pH of the polishing composition to an intended value. The pH adjusting agent to be used may be any one of acids and alkalis, and may be any one of inorganic compounds and organic compounds. Furthermore, the pH adjusting agent may be used alone or in the mixture of two or more members thereof. In addition, as the various members of additives described above, in a case where a member having a pH adjusting function (for example, various kinds of acids and the like) is used, the additive may be used as at least part of the pH adjusting agent.

### [Method for Manufacturing Polishing Composition]

A method for manufacturing the polishing composition of the invention is not particularly limited, and the polishing composition can be obtained, for example, by the stirring and mixing of an oxidizing agent, a nonionic compound, and other components as needed in water.

The temperature at the time of mixing each component is not particularly limited; however, it is preferably 10 to 40° C., and may be raised by heating in order to increase the rate of dissolution. Furthermore, the mixing time is not also particularly limited.

### [Polishing Method and Method for Manufacturing Substrate]

As described above, the polishing composition of the invention is suitably used for the polishing of the polishing object having a barrier layer, a metal wiring layer, and an insulation film. Therefore, the invention provides a polishing method of polishing the polishing object having a barrier layer, a metal wiring layer, and an insulation film with the polishing composition of the invention. Furthermore, the invention provides a method for manufacturing a substrate comprising a process of polishing the polishing object having a barrier layer, a metal wiring layer, and an insulation film with the polishing method described above.

As a polishing device, a common polishing device can be used, in which a holder for holding a substrate having the polishing object and the like, and a motor capable of changing the rotation speed and the like are installed, and a polishing surface plate capable of attaching a polishing pad (polishing cloth) is provided.

As the polishing pad, common nonwoven fabric, polyurethane, a porous fluorine resin and the like can be used without any particular limitation. The polishing pad is preferably provided with grooves so as to store a polishing liquid.

Polishing conditions are not also particularly limited, for example, the speed of rotation of the polishing surface plate is preferably 10 to 500 rpm, and the pressure applied to the substrate having a polishing object (polishing pressure) is preferably 0.5 to 10 psi. A method for supplying the polishing composition to the polishing pad is not particularly limited, and for example, a method for supplying the composition continuously with a pump and the like is employed. The supply amount is not limited; however, preferably, the surface of the polishing pad is constantly covered with the polishing composition of the invention.

After the completion of the polishing, the substrate is washed in running water, water droplets adhered onto the substrate are shaken off with a spin dryer and the like and dried, and as a result, a substrate having a barrier layer, a metal wiring layer, and an insulation film can be obtained.

The polishing composition of the invention may be a one-pack type, or may be a multi-pack type including a two-pack type. Furthermore, the polishing composition of the invention may be prepared by diluting the stock solution of the polishing composition with a diluent such as water, for example, by diluting ten times or more.

### EXAMPLES

The invention will be described in more detail with the following Examples and Comparative examples. However, the technical scope of the invention is not limited to only the following Examples.

### Examples 1 to 7 and Comparative Examples 1 to 7

10% by weight of colloidal silica (an average secondary particle diameter of about 70 nm, (an average primary particle diameter of 35 nm, and a degree of association of 2) as the abrasive grains, 0.6% by weight of hydrogen peroxide as the oxidizing agent, 4.2 g/L of isethionic acid as the complexing agent, 1.2 g/L of 1H-BTA as the metal corrosion inhibitor, and 1.5 g/L of nonionic compound shown in the following Table 2, were stirred and mixed in water (mixing temperature: about 25° C., mixing time: about 10 minutes) in order that each became the concentration described above, and a polishing composition was prepared. The pH of the composition was adjusted with the addition of potassium hydroxide (KOH), and confirmed with a pH meter. Furthermore, the weight average molecular weight of the nonionic compound was measured with GPC (gel permeation chromatography) using polystyrene as a standard substance.

As a polishing object, a 12-inch wafer in which a Ta film, a Ru film, a TEOS film, and a Black Diamond (registered trademark: BDIIx) film had been formed on a silicon substrate was used.

By using the obtained polishing composition, the polishing rate was measured when the surface of the polishing object was polished for 60 seconds under the polishing conditions shown in the following Table 1. The polishing rate was determined by the way in which differences in respective thickness of the films before and after the polishing measured with a sheet resistance measuring instrument based on a DC 4-probe method as a principle are divided by the polishing time.

TABLE 1

Polishing device: CMP one-side polishing device
Polishing pad: Made of polyurethane
Polishing pressure: 1 psi (6.9 kPa)
Polishing surface plate speed: 80 rpm
Flow rate of slurry: 300 mL/min
Polishing time: 60 seconds

Furthermore, as to the dispersion stability of the abrasive grains in the composition, the polishing composition was stored for two months in a thermo-hygrostat at 43° C. (corresponding to storing for 6 months at room temperature (25° C.)), and then the dispersion stability of the abrasive grains was visually observed. The evaluation results are shown in the following Table 2. In Table 2, ◯ shows that aggregation of abrasive grains did not occur, and X shows that aggregation of abrasive grains occurs.

TABLE 2

| | Composition | | | Polishing rate (Å/min) | | | | | |
|---|---|---|---|---|---|---|---|---|---|
| | Nonionic compound | | | | | Insulation | Low dielec- | Abrasive grain | |
| | | Weight average | | Barrier layer | | film | tric material | dispersion stability | |
| | Member | molecular weight | pH | Ta | Ru | TEOS | BDII_{X} | Evaluation | Remarks |
| Example 1 | POE alkyl ether *¹ | 900 | 10 | 507 | 374 | 371 | 97 | ◯ | |
| Example 2 | Polyethylene | 400 | 10 | 508 | 360 | 410 | 559 | ◯ | |
| | glycol | | | | | | | | |
| Example 3 | Polypropylene | 400 | 10 | 514 | 392 | 397 | 473 | ◯ | |
| | glycol | | | | | | | | |
| Example 4 | Polypropylene | 750 | 10 | 495 | 346 | 392 | 389 | ◯ | |
| | glycol | | | | | | | | |
| Comparative | None | — | 10 | 528 | 357 | 426 | 962 | ◯ | |
| example 1 | | | | | | | | | |
| Comparative | POE-POP-glycol *² | 2000 | 10 | 472 | 351 | 370 | 220 | X | White turbidness |
| example 2 | | | | | | | | | |
| Comparative | Hydroxyethyl | 25000 | 10 | — | — | — | — | X | White turbidness |
| example 3 | cellulose | | | | | | | | → Too severe to |
| | | | | | | | | | be polished |
| Comparative | Polyvinyl alcohol | 22000 | 10 | — | — | 396 | 662 | X | White turbidness |
| example 4 | | | | | | | | | |
| Example 5 | Polyethylene | 400 | 3 | 405 | 244 | 520 | 651 | ◯ | |
| | glycol | | | | | | | | |
| Example 6 | Polypropylene | 400 | 3 | 445 | 262 | 498 | 537 | ◯ | |
| | glycol | | | | | | | | |
| Example 7 | Polypropylene | 750 | 3 | 430 | 252 | 511 | 520 | ◯ | |
| | glycol | | | | | | | | |
| Comparative | None | — | 3 | 396 | 257 | 526 | 1028 | ◯ | |
| example 5 | | | | | | | | | |
| Comparative | POE-POP-glycol | 2000 | 3 | 408 | 231 | 486 | 189 | X | White turbidness |
| example 6 | | | | | | | | | |
| Comparative | Hydroxyethyl | 25000 | 3 | — | — | — | — | X | White turbidness |
| example 7 | cellulose | | | | | | | | → Too severe to |
| | | | | | | | | | be polished |

*¹ Polyoxyethylene alkyl ether
*² Polyoxyethylene polyoxypropylene glycol

As shown in the above Table 2, it was found that in the polishing composition of the invention (Examples 1 to 7), each polishing rate of tantalum and ruthenium used as the barrier layer, and of TEOS used as the insulation film was not largely decreased, and also the polishing rate of Black Diamond (registered trademark) as the low dielectric material was decreased, as compared with the polishing composition not comprising a nonionic compound in Comparative examples 1 and 5.

In addition, in the polishing composition of the invention (Examples 1 to 7), aggregation of abrasive grains did not occur; however, in the polishing composition of Comparative examples 2 to 4, 6, and 7 comprising the nonionic compound of which the weight average molecular weight is outside the range of the invention, aggregation of abrasive grains occurred. In particular, in Comparative examples 3 and 7 using the hydroxyethyl cellulose of which the number average molecular weight was 25,000, aggregation of the abrasive grains was severe, and polishing could not be performed at all.

Moreover, in the polishing composition of Comparative example 4, only polishing of the low dielectric material and the insulation film was performed, and it was found that the polishing rate of the low dielectric material was not decreased.

Furthermore, the present application is based on Japanese Patent Application No. 2012-203104, filed on Sep. 14, 2012, the entire contents of which are incorporated herein by reference.

1. A polishing composition to be used for an application of polishing an polishing object having a barrier layer, a metal wiring layer, and an insulation film, comprising:
an oxidizing agent; and
a nonionic compound having a weight average molecular weight of 1,000 or less.

2. The polishing composition according to claim 1, wherein the nonionic compound is a compound having an alkyl ether chain.

3. The polishing composition according to claim 2, wherein the alkyl ether chain has a structure represented by the chemical formula (1) or (2):
[Chem. 1]
—(CH₂CH₂O)ₙ— (1)
—(CH₂CH₂CH₂O)ₘ— (2)
wherein n is an integer of 1 to 23 in the chemical formula (1), and m is an integer of 1 to 15 in the chemical formula (2).

4. The polishing composition according to claim 1, wherein the polishing object further comprises a low dielectric material.

5. The polishing composition according to claim 1, wherein the barrier layer comprises tantalum or a noble metal.

6. A method for polishing, comprising:
polishing the polishing object having the barrier layer and the metal wiring layer with the polishing composition according to claim 1.

7. A method for producing a substrate, comprising:
polishing the polishing object having the barrier layer and the metal wiring layer with the method for polishing according to claim 6.
